(19) United States
(12) Patent Application Publication
(10) Pub. No.: US 2006/0062012 A1
(43) Pub. Date: Mar. 23, 2006

(54) Vehicle lamp with two lighting circles

(76) Inventor: Yun-Yu Tsai, Taipei Hsien (TW)

Correspondence Address: Yun-Yu TSAI, 235 Chung-Ho, Box 8-24, Taipei, TW

(21) Appl. No.: 10/984,712

(22) Filed: Nov. 10, 2004

(30) Foreign Application Priority Data
Sep. 23, 2004 (TW) 093215223

(51) Int. Cl. F21V 5/00

(52) U.S. Cl. 362/520

(57) ABSTRACT

A vehicle lamp with two lighting circles comprises a reflecting mask being a mask with a cambered reflecting shield; a light transmitting shield sealing a front side of the reflecting mask; a stop ring installed within the reflecting shield; the stop ring dividing an interior of the reflecting mask into a central light emitting area and an outer annular light emitting area; a main light emitting body embedded into a central through hole at a rear side of the reflecting shield; a first bulb received in an interior of the central light emitting area; and at least one sub-light emitting body having a lamp seat which is installed near a small through hole near an outer edge of the reflecting shield; a second bulb passing into the outer annular light emitting area. By the main light emitting body and the sub-light emitting body, different light effects are presented.

### FIELD OF THE INVENTION

The present invention relates to vehicle lamps, and particularly to a vehicle lamp with two lighting circles, wherein one central light emitting area and one outer annular light emitting area are defined so as to generate different light effect, which is suitable to cars, motorcycles, etc.

### BACKGROUND OF THE INVENTION

In the prior art, the main light and auxiliary light are separated into two lamps or are distributed in two sides of one lamp body. Furthermore, the lights are used with light emitting bodies of different power or light transmitting shields of different colors for illumination, alert, or as fog lights or auxiliary lights. In one prior art, an inner reflecting mask is installed within an outer reflection mask and the two are spaced. A light transmitting shield 5 is in front of the inner and outer reflecting masks and seals the two masks. A main light emitting body 1 is placed in the inner reflecting mask and a sub-light emitting body is placed between the inner reflecting mask and the outer reflecting mask so that the car light emits white light at a center thereof and emits color light at an outer side.

Furthermore, in another prior art, the inner and outer reflecting masks are formed as a casing. A transparent glass shield is installed in front of the casing. A main light is installed at a center of the inner reflecting mask and an outer annular side of the inner reflecting mask is installed with a round neon lamp so that the center portion of the car lamp emits white light and the outer side thereof generates a light circle.

In one prior art, the outer reflecting mask and the inner reflecting mask are separated from one another. The inner reflecting mask is installed within the outer reflecting mask so as to form a central light emitting area and an outer annular light emitting area. The two reflecting masks are not integrally formed, but they are secured by screwing. Thereby the manufacturing process is complicated. Otherwise, three modules are needed in the manufacturing process so that cost is high and is not economical.

In other prior arts, no central light emitting area and outer annular light emitting area is defined so that the light from the neon lamp will mix with the white light radiated from the center portion. Thus, the light color is not clear.

### SUMMARY OF THE INVENTION

Accordingly, the primary object of the present invention is to provide a vehicle lamp with two lighting circles, wherein the light from the central light emitting area and light from the outer annular light emitting area will not be mixed.

Another object of the present invention is to provide a vehicle lamp with two lighting circles, wherein the structure of the lamps make preferred light guide and focus effect so that the light from the central light emitting area is bright.

A further object of the present invention is to provide a vehicle lamp with two lighting circles, wherein the sub-light emitting bodies in the outer cycles may have different colors so as to present different light effects.

To achieve above objects, the present invention provides a vehicle lamp with two lighting circles which comprises a reflecting mask being a mask with a cambered reflecting shield; a light transmitting shield sealing a front side of the reflecting mask; a stop ring installed within the reflecting shield; a top edge of the stop ring being sealed tightly to an inner wall of the light transmitting shield; the stop ring dividing an interior of the reflecting mask into a central light emitting area and an outer annular light emitting area; the central light emitting area being an area within the stop ring and the outer annular light emitting area being an area out of the stop ring; a main light emitting body embedded into a central through hole at a rear side of the reflecting shield; a first bulb received in an interior of the central light emitting area; and at least one sub-light emitting body having a lamp seat which is installed near a small through hole near an outer edge of the reflecting shield; a second bulb passing into the outer annular light emitting area. By the main light emitting body and the sub-light emitting body, different light effects are presented.

Furthermore, in the present invention, an inner wall of the light transmitting shield has a plurality of refraction textures at a position corresponding to the outer annular light emitting area; and the refraction textures are arranged annularly. Or an out wall of the stop ring has a plurality of refraction textures at a position corresponding to the outer annular light emitting area; and the refraction textures are arranged annularly. Or more than one sub-light emitting body are installed on the outer annular light emitting area.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIG. 3 is a cross sectional view of the present invention.

FIG. 4 is a schematic view showing the operation of the central light emitting area of the present invention.

FIG. 5 is a schematic view showing the operation of the outer annular light emitting area of the present invention.

FIG. 6 is a schematic view showing the operation of the central light emitting area and the outer annular light emitting area according to the present invention.

FIG. 7 is a cross sectional view of the present invention, wherein a reduced tapered annular frame is illustrated.

FIG. 8 is a cross sectional view of the present invention, wherein an expanding tapered annular frame is illustrated.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

Referring to appended drawings, the present invention will be described herein.

FIG. 1 shows an exploded perspective view of the present invention. It is illustrated that lamp 10 of the present invention has the following elements.

A reflecting mask 11 is a casing like structure made of opaque plastics or metal casing. The reflecting mask 11 has a mask with a cambered reflecting shield 110.

A light transmitting shield 12 seals a front side of the reflecting mask 11. The light transmitting shield 12 is made of transparent glass or heat-tolerant resin.

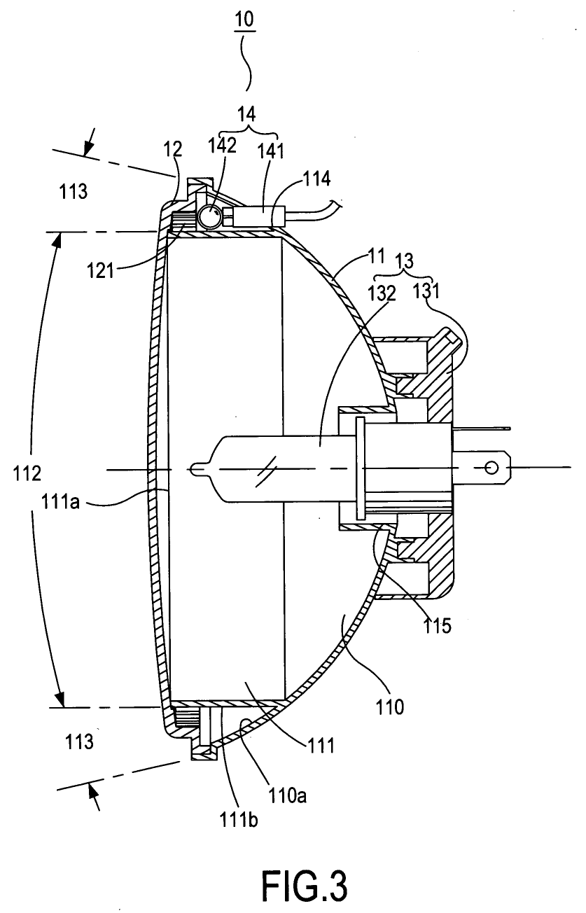

A stop ring 111 parallel to a central shaft of the reflecting mask 11 is installed within the reflecting shield 110. A top edge 111a of the stop ring 111 is sealed tightly to an inner wall of the light transmitting shield 12 (referring to FIG. 3). Since in the manufacturing process, the stop ring 111 and the reflecting mask 11 are integrally formed so that the molding process and the succeeding work can be performed easily. Thus, the cost is down. Furthermore, the stop ring 111 divides the interior of the reflecting mask 11 into a central light emitting area 112 and an outer annular light emitting area 113. The central light emitting area 112 is an area within the stop ring 111 and the outer annular light emitting area 113 is an area out of the stop ring 111.

A main light emitting body 13 has a fixing seat 131. The main light emitting body 13 is embedded into a central through hole 115 at a rear side of the reflecting shield 110. A bulb 132 (general, a car-used bulb) is inserted into the interior of the central light emitting area 112.

A sub-light emitting body 14 (for example, light emitting diodes or small halogen lamp) has a lamp seat 141 which is installed near a small through hole 114 near an outer edge of the reflecting shield 110. The bulb 142 (or LED) passes into the outer annular light emitting area 113. In application, it is preferred that the color of the light of the sub-light emitting body 14 is different from that of the main light emitting body 13. For example, the main light emitting body 13 emits white light, while the sub-light emitting body 14 emits blue light, red light or yellow light, etc. so that the lamp can emit two lights of different colors. Furthermore, more than one sub-light emitting bodies 14 can be installed on the outer annular light emitting area 113. Thereby the colors of the lights from the sub-light emitting bodies 14 may be different.

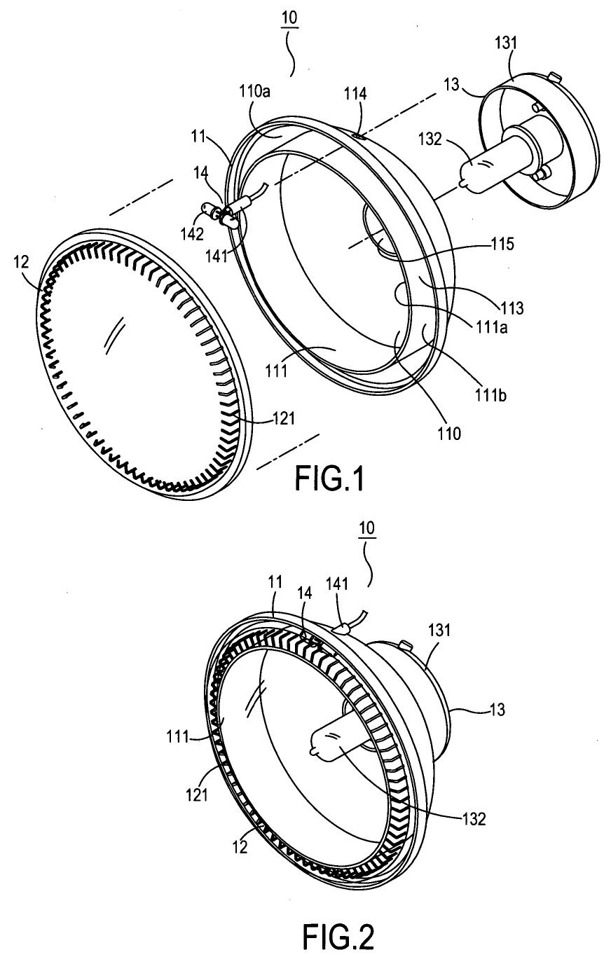

A perspective view of the assembled lamp is illustrated in FIG. 2.

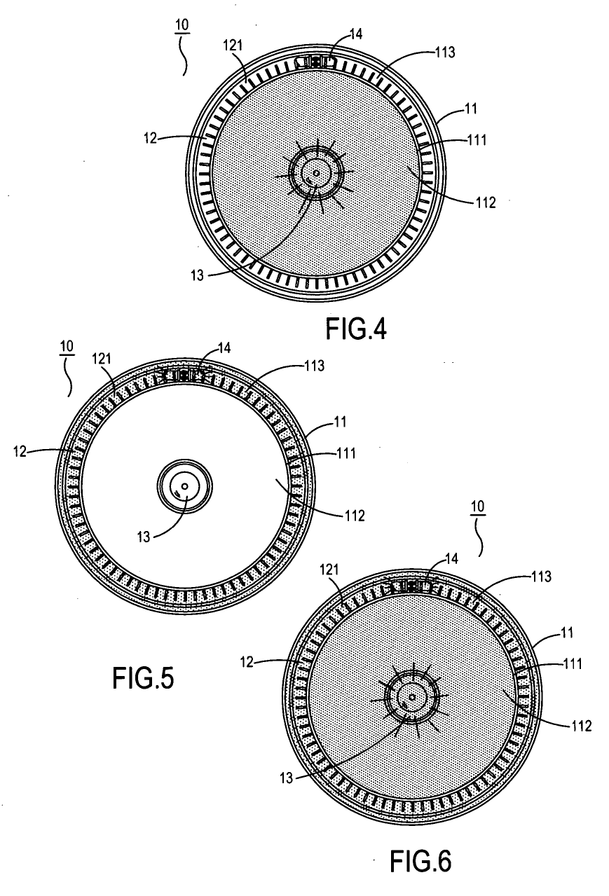

When the main light emitting body 13 lights up, the central light emitting area 112 of the lamp 10 will light up and illuminates (referring to FIG. 4). When the sub-light emitting body 14 lights up, the outer annular light emitting area 113 illuminates and generates a light circle (referring to FIG. 5). When the main light emitting body 13 and sub-light emitting body 14 light up simultaneously, the central light emitting area 112 and the outer annular light emitting area 113 generate double light circles (referring to FIG. 6).

Next, FIG. 3 shows a schematic view of the present invention. It is illustrated that an inner wall of the light transmitting shield 12 has a plurality of refraction textures 121 (referring to FIGS. 1, and 2) at a position corresponding to the outer annular light emitting area 113. The refraction textures 121 are arranged annularly and equally spaced. The refraction textures 121 like a light circle which can guide the light from the sub-light emitting body 14 to the outer annular light emitting area 113 so as to form a light circle. Similarly, the refraction textures 121 can be installed on the interior wall of the outer annular light emitting area 113, for example, on the outer wall 111b of the stop ring 111 or the inner wall 110a of the reflecting shield 110. It can achieve the same effect.

Besides, the top edge 111a of the stop ring 111 is tightly engaged so as to prevent the main light emitting body 13 and the sub-light emitting body 14 light up at the same time to generate light interference. Thereby by the isolation of the stop ring 111, the car lamp 10 can emit two lights.

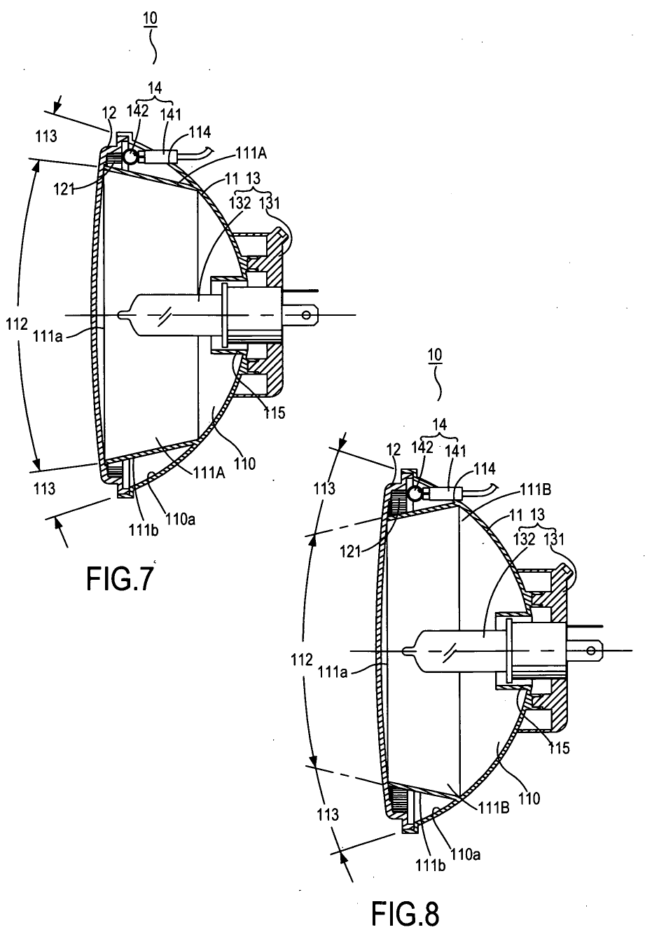

In the present invention, the stop ring 111 may have a shape of a cylinder having an equal radius at different axial point. However as shown in FIG. 7, the stop ring 111 may be a reduced tapered annular frame 111A with a large opening near the light transmitting shield 12. Or referring to FIG. 8, the stop ring 111 is an expanded tapered annular frame 111B with a small opening near the light transmitting shield 12. The reduced tapered annular frame 111A will make the range of the central light emitting area 112 enlarged and the outer annular light emitting area 113 become smaller. The expanded tapered annular frame 111B will make the central light emitting area 112 become smaller and the outer annular light emitting area 113 becomes larger.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle lamp with two lighting circles comprising:
a reflecting mask being a mask with a cambered reflecting shield;
a light transmitting shield sealing a front side of the reflecting mask;
a stop ring installed within the reflecting shield; a top edge of the stop ring being sealed tightly to an inner wall of the light transmitting shield; the stop ring dividing an interior of the reflecting mask into a central light emitting area and an outer annular light emitting area; the central light emitting area being an area within the stop ring and the outer annular light emitting area being an area out of the stop ring;
a main light emitting body embedded into a central through hole at a rear side of the reflecting shield; a first bulb received in an interior of the central light emitting area; and
at least one sub-light emitting body having a lamp seat which is installed near a small through hole near an outer edge of the reflecting shield; a second bulb passing into the outer annular light emitting area;
wherein by the main light emitting body and the sub-light emitting body, different light effects are presented.

2. The vehicle lamp with two lighting circles as claimed in claim 1, wherein an inner wall of the light transmitting shield has a plurality of refraction textures at a position corresponding to the outer annular light emitting area; and the refraction textures are arranged annularly.

3. The vehicle lamp with two lighting circles as claimed in claim 1, wherein an out wall of the stop ring has a plurality of refraction textures at a position corresponding to the outer annular light emitting area; and the refraction textures are arranged annularly.

4. The vehicle lamp with two lighting circles as claimed in claim 1, wherein more than one sub-light emitting body are installed on the outer annular light emitting area.
